(19) United States
(12) Patent Application Publication
(10) Pub. No.: US 2008/0184013 A1
(43) Pub. Date: Jul. 31, 2008

(54) Print setting instructing device, information processor, printing process system, print setting instructing system, print setting instructing method, and computer readable medium

(75) Inventor: Shusuke Tanimoto, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/898,862

(22) Filed: Sep. 17, 2007

(30) Foreign Application Priority Data
Jan. 26, 2007 (JP) 2007-016815

(51) Int. Cl. G06F 9/318

(52) U.S. Cl. 712/226; 712/E09.035

(57) ABSTRACT

A print setting instructing device includes: a receiving unit that receives a first control instruction, which shows a print condition, embedded in a printed; a determining unit that determines whether or not the first control instruction received by the receiving unit needs to be converted into a second control instruction; and a converting unit that converts the first control instruction into the second control instruction in a case where the determining unit determines that the converting the first control instruction into the second control instruction is necessary.

### CROSS-REFERENCE TO RELATED APPLICATIONS

This application is based on and claims priority under 35 U.S.C. 119 from Japanese Patent Application No. 2007-016815 filed Jan. 26, 2007.

### BACKGROUND

1. Technical Field

The present invention relates to a print setting instructing device, an information processor, a printing process system, a print setting instructing system, a print setting instructing method, and a computer readable medium.

2. Related Art

In addition to a control method or an image processor that controls various printing functions by an instruction (command) of a printing device control language, there is an image processor in which an instruction supplied from an application during printing a document is embedded in print information so that a function (what is called a pass through function) can be performed for making it possible to control the image processor without setting by the use of a print setting instructing device by a user.

### SUMMARY

(1) According to an aspect of the present invention, a print setting instructing device includes: a receiving unit that receives a first control instruction, which shows a print condition, embedded in a printed; a determining unit that determines whether or not the first control instruction received by the receiving unit needs to be converted into a second control instruction; and a converting unit that converts the first control instruction into the second control instruction in a case where the determining unit determines that the converting the first control instruction into the second control instruction is necessary.

### BRIEF DESCRIPTION OF THE DRAWINGS

Exemplary embodiment of the present invention will be described in detail based on the following figures, wherein:

FIG. 1 is a block diagram showing a structure of a printing process system including a program according to a first embodiment of the present invention;

FIGS. 2A and 2B are explanatory views showing a structural example of a command in a created document and a structural example of a print file formed by a printer driver, respectively;

FIGS. 3A and 3B are explanatory views showing an example that a printing operation can be carried out perfectly in accordance with print information;

FIGS. 4A to 4D are explanatory views showing an example that a printing operation cannot be carried out in accordance with the print information;

FIG. 5 is a flowchart showing a procedure of a printing process carried out by the printer driver of the printing process system according to the embodiment of the present invention;

FIG. 6 is a flowchart showing a procedure of a printing process mainly carried out by a printer of the printing process system according to the embodiment of the present invention;

FIG. 7 is a table showing an example that a pass through command is converted into a converted command that can be interpreted by the printer and has the contents of control as those of the pass through command; and

FIG. 8 is a block diagram showing a structure of a printing process system including a program according to a second embodiment of the present invention.

### DETAILED DESCRIPTION

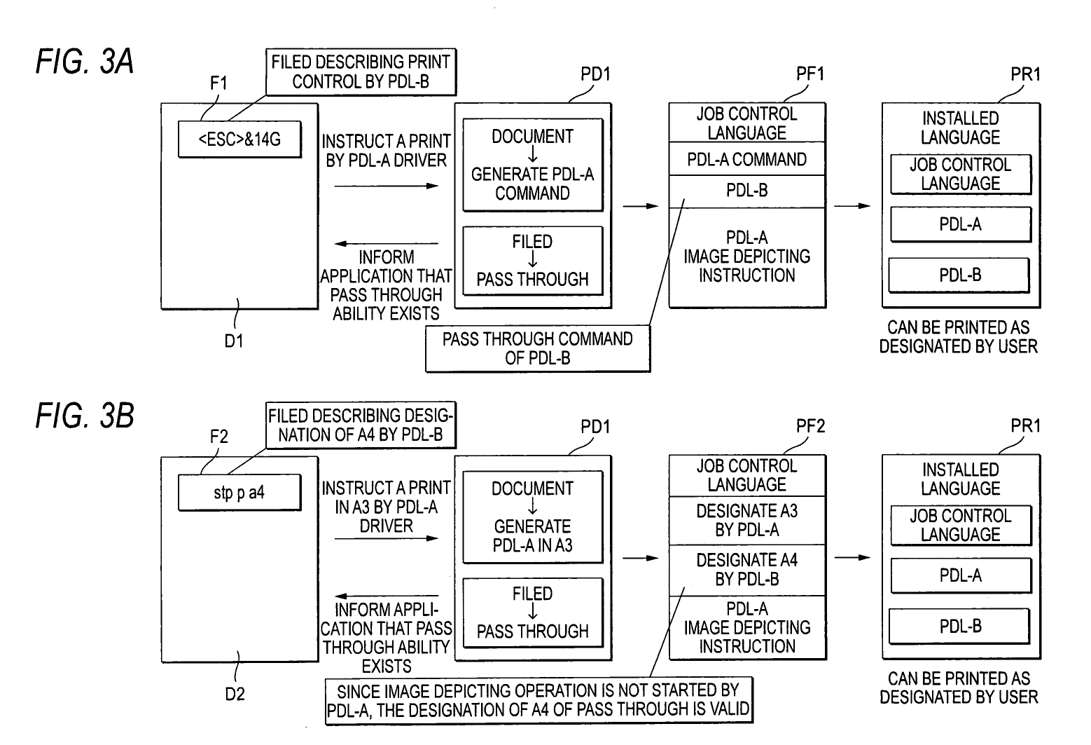

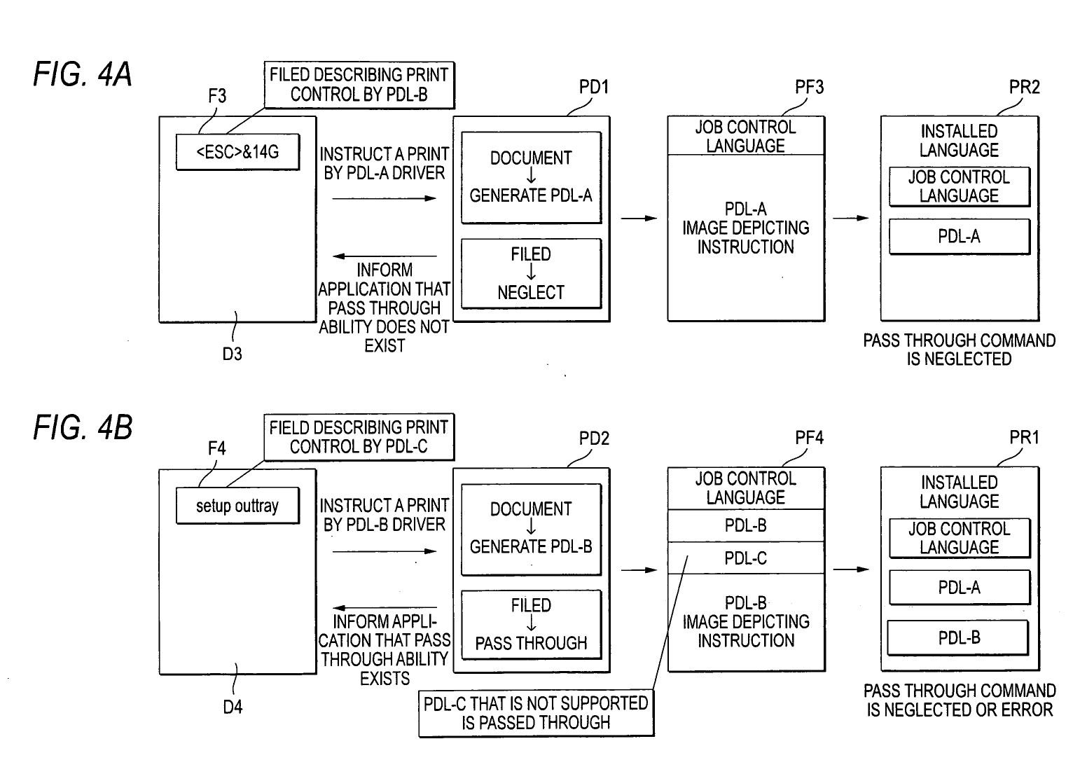

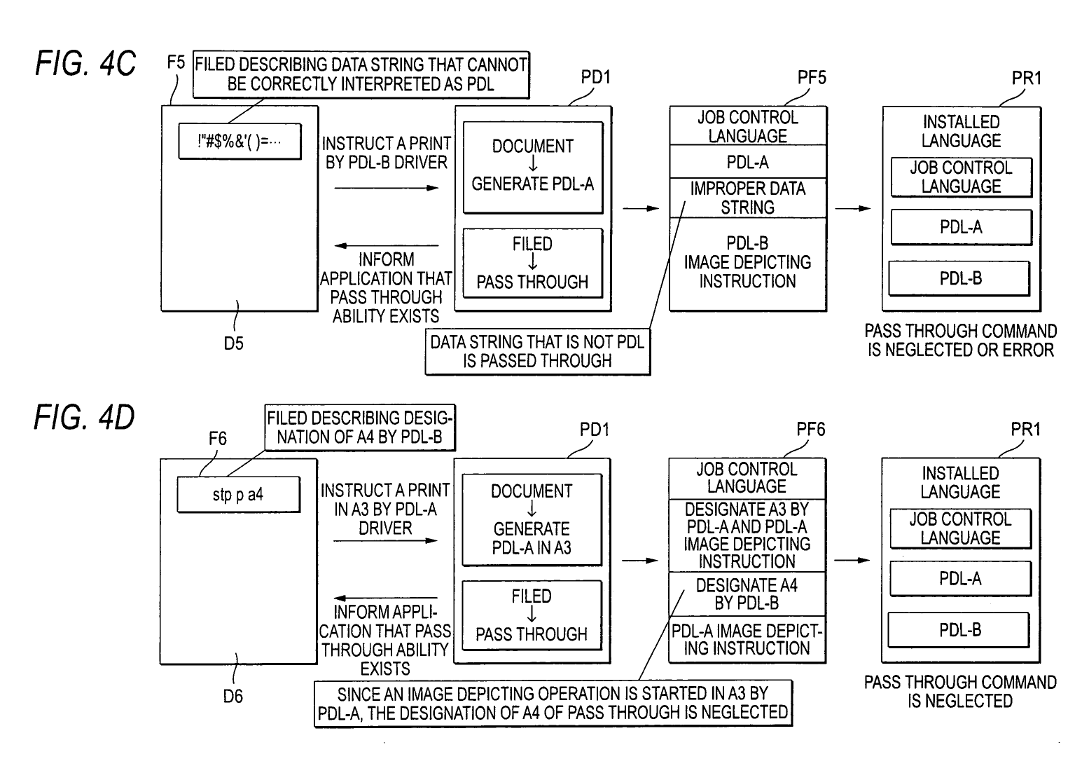

Now, referring to FIGS. 3 and 4, the operation of the pass through function will be described below.

Initially, as a precondition, it is assumed that PDL-A and PDL-B shown in FIGS. 3 and 4 designate a page describing language that supports the pass through function (examples: PDL-A=PCL-XL, PDL-B=PCL5) and PDL-C designates a page describing language that supports the pass through function, however, is not supported by a printer.

All printers shown in FIGS. 3A and 3B and FIGS. 4B, 4C and 4D can carry out a process using the pass through function. However, since a printer shown in FIG. 4A does not support the pass through function, this printer cannot carry out the pass through process. Further, in the printers shown in FIGS. 4B, 4C and 4D, a factor from which a problem arises is included.

FIGS. 3A and 3B show examples that a printing operation can be carried out perfectly in accordance with initial print information.

In FIG. 3A, in the first part of a document D1 formed by an application such as Word, a field F that a control instruction of “<ESC>&14G” is described by the PDL-B is provided. Here, the field means a column that an instruction (what is called a pass through command) for carrying out the pass through process is described when the process using the pass through function is carried out.

Then, a printer driver PD1 by the PDL-A is set so as to generate a PDL-A command on the basis of the print information related to the document D1 and carry out the pass through process for the instruction described in the filed F1. In the example shown in FIG. 3A, since a printer PR1 supports the pass through function by the PDL-B, the application is informed that the printer driver PD1 has an ability to carry out the pass through function (that is, supports the pass through function).

In such a way, a print file PF1 that is formed from the first position to an image depicting instruction by PDL-A . . . via printer job control language (job control language:PJL), PDL-A command and pass through command of PFL-B is created and supplied to the printer PR1.

In this case, since the printer driver PD1 and the printer PR1 support the pass through function by the PDL-B, both the PDL-A and PDL-B are effectively designated.

Since the driver and the printer shown in FIG. 3A support the pass through function by the PDL-B, both the PDL-A and PDL-B are effectively designated. Thus, an output is obtained as designated by a user.

Further, in FIG. 3B, in the first part of a document D2 formed by the application such as Word, a field F2 that a control instruction for instructing to designate A4 of “stp p a4” is described by the PDL-B is provided. Further, a print on A3 is instructed by a printer driver PD1.

In the example shown in FIG. 3B, since a printer PR1 supports the pass through function by the PDL-B, the application is informed that the printer driver PD1 has an ability to carry out the pass through process (that is, supports the pass through function).

Then, the printer driver PD1 by the PDL-A is set so as to form a PDL-A command for instructing to designate A3 on the basis of print information related to the document D2 and carry out the pass through process for the instruction described in the field F2.

In such a way, a print file PF2 that is formed from the first position to an image depicting instruction by the PDL-A . . . via the job control language, a PDL-A command (designation of A3), a pass through command of the PDL-B (designation of A4) is created and delivered to the printer PR1. Under this state, the designation of A3 by the PDL-A command is inconsistent with the designation of A4 by the pass through command of the PDL-B, however, since an image depicting operation by the PDL-A is not started, the designation of A4 by the pass through command of the PDL-B is effective. Thus, a printing operation is carried out by the printer PR1 that supports the pass through function.

Further, FIGS. 4A to 4D show cases that setting conditions provided by using the pass through function are neglected or an error arises by considering a printing process to be impossible.

In FIG. 4A, in the first part of a document D3 formed by the application such as Word, a field F3 that a control instruction of “<ESC>&14G” is described by the PDL-B is provided.

In an example shown in FIG. 4A, since a printer PR2 does not support the pass through function by the PDL-B, the application is informed that a printer driver PD1 has no ability to carry out the pass through process (that is, does not support the pass through function).

Then, the printer driver PD1 by the PDL-A generates a PDL-A command on the basis of print information related to the document D3 and a pass through command described in the filed F3 is neglected. In such a way, a print file PF3 that is formed from the first position to an image depicting instruction by the PDL-A . . . via the printer job control language (job control language:PJL) is created and supplied to the printer PR2. Accordingly, a pass through command designated by the creator of the document is neglected and not reflected on a printed result.

In FIG. 4B, in the first part of a document D4 formed by the application such as Word, a field F4 that a control instruction of “step outtray 1” is described by the PDL-C is provided.

In an example shown in FIG. 4B, the application is informed that a printer driver PD2 by the PDL-B has an ability to carry out the pass through process (that is, supports the pass through function).

Then, the printer driver PD2 by the PDL-B is set so as to generate a PDL-B command on the basis of print information related to the document D4 and carry out the pass through process for the instruction described in the field F4. In such a way, a print file PF4 that is formed from the first position to an image depicting instruction by the PDL-B . . . via the job control language, the PDL-B command and a PDL-C command is created and supplied to a printer PR1. However, since a pass through command by the PDL-C designated by the creator of the document is not supported by the printer PR1, there is a fear that a printed result having the pass through command neglected is obtained or an error arises by considering a printing process to be impossible.

In FIG. 4C, in the first part of a document D5 formed by the application such as Word, a field F5 that a data string, for instance, “!”#$%&′( )= . . . ” which cannot be correctly interpreted as a PDL is described by the PDL-B is provided. Further, a print instruction is outputted by a printer driver PD1 by the PDL-A.

In an example shown in FIG. 4C, since a printer PR1 supports the pass through function by the PDL-B, the application is informed that the printer driver PD1 has an ability to carry out the pass through process (that is, supports the pass through function).

Then, the printer driver PD1 by the PDL-A is set so as to form a PDL-A command on the basis of print information related to the document D5 and carry out the pass through process for the instruction described in the field F5. In such a way, a print file PF5 that is formed from the first position to an image depicting instruction by the PDL-A . . . via the job control language, the PDL-A command and an improper data string is created and delivered to the printer PR1. Accordingly, since the improper data string that cannot be interpreted by the printer PR1 is included as the pass through command, there is a fear that a printed result having the pass through command neglected or an error arises by considering a printing process to be impossible.

In FIG. 4D, in the first part of a document D6 formed by the application such as Word, a field F6 that a control instruction for instructing to designate A4 of “stp p a4” is described by the PDL-B is provided. Further, a print on A3 is instructed by a printer driver PD1.

In an example shown in FIG. 4D, since a printer PR1 supports the pass through function by the PDL-B, the application is informed that the printer driver PD1 has an ability to carry out the pass through process (that is, supports the pass through function).

Then, the printer driver PD1 by the PDL-A is set so as to form a PDL-A command for instructing to designate A3 on the basis of print information related to the document D6 and carry out the pass through process for the instruction described in the field F6.

In such a way, a print file PF6 that is formed from the first position to an image depicting instruction by the PDL-A . . . via the job control language, the PDL-A command (designation of A3)+an image depicting instruction and a pass through command of the PDL-B (designation of A4) is created and delivered to the printer PR1. Under this state, the designation of A3 by the PDL-A command is inconsistent with the designation of A4 by the pass through command of the PDL-B. However, since an image depicting operation of A3 by the PDL-A is started, the designation of A4 by the pass through command of the PDL-B is invalid. As a result, a printed result having the pass through command neglected is obtained.

Now, an embodiment as one example of the present invention will be described in detail by referring to the drawings. Here, in the accompanying drawings, the same members are designated by the same reference numerals and a duplicated explanation is omitted. Since a description is herein directed to a best mode for carrying out the present invention, the present invention is not limited to this embodiment.

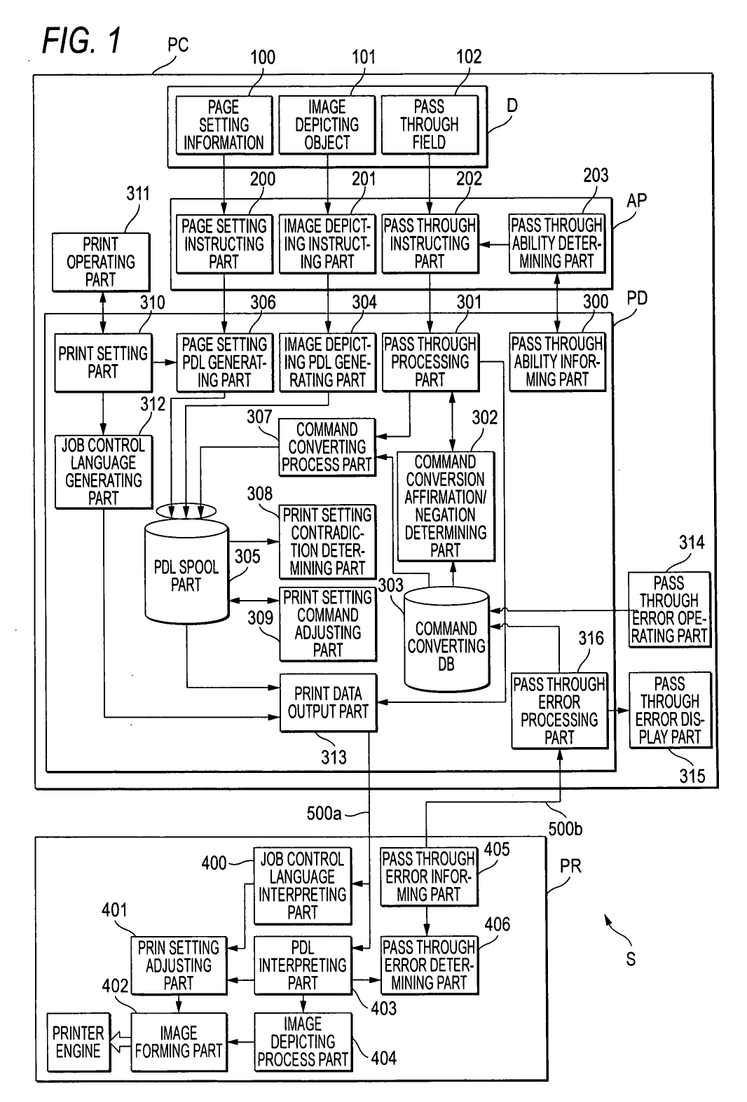

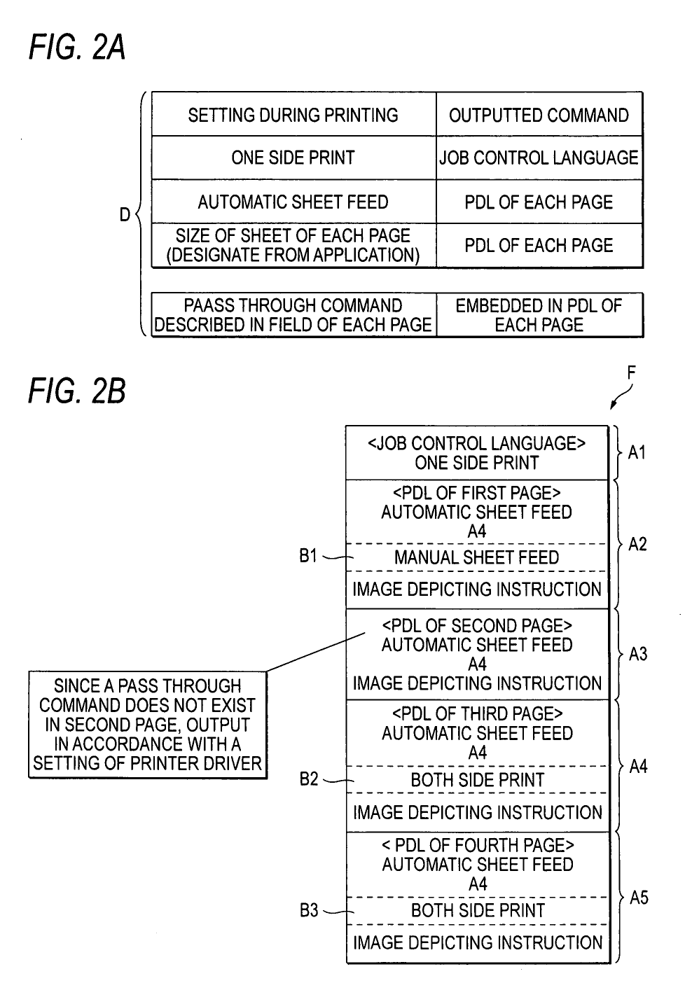

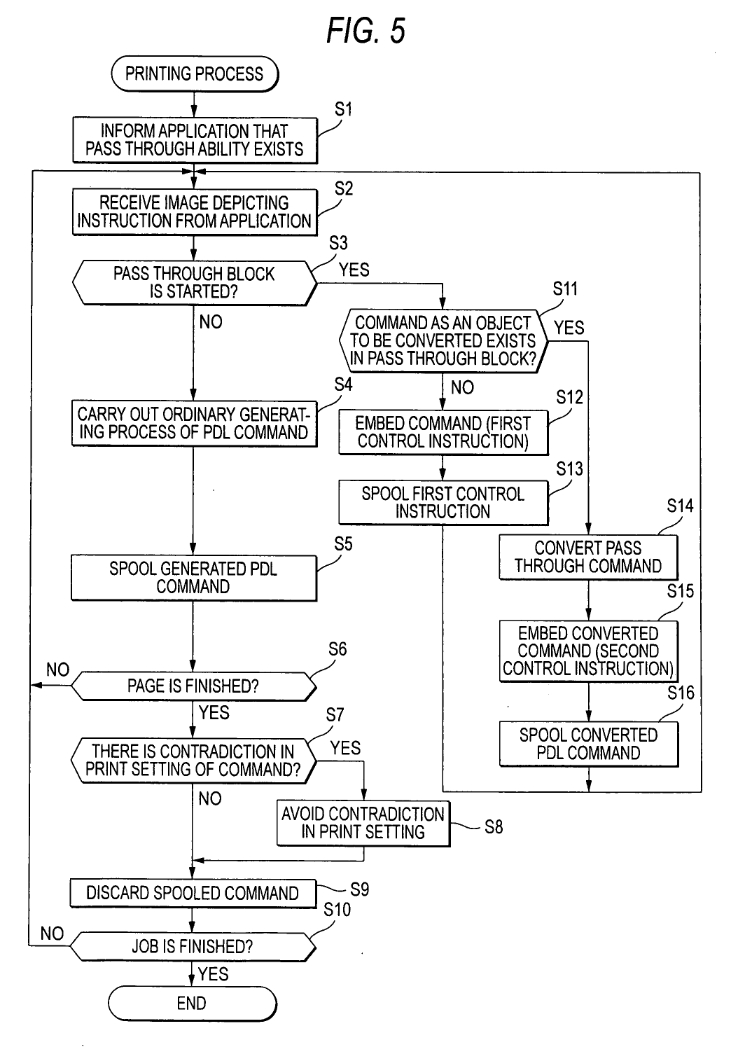

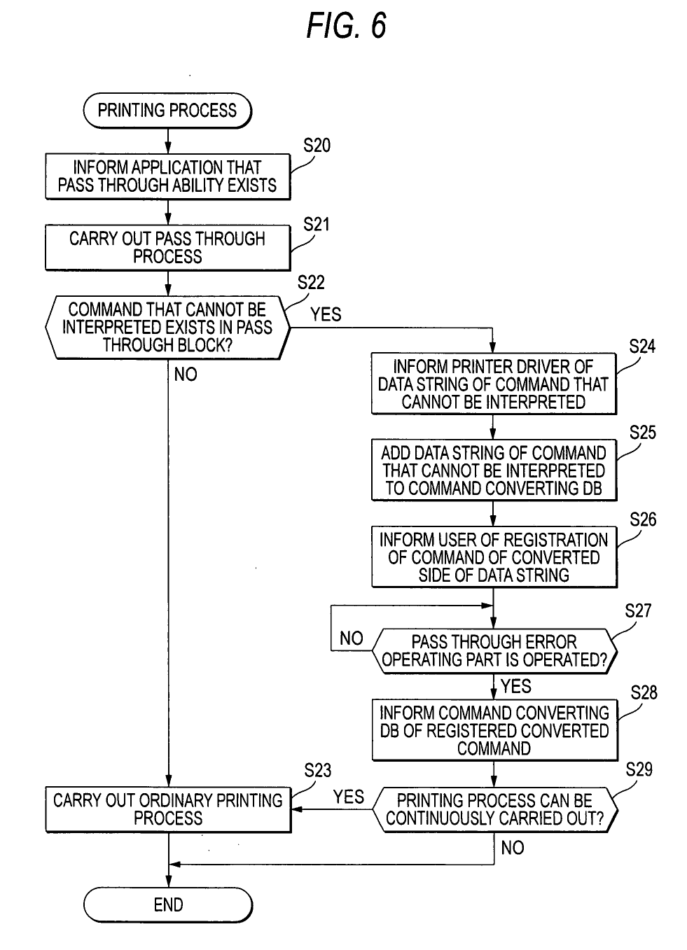

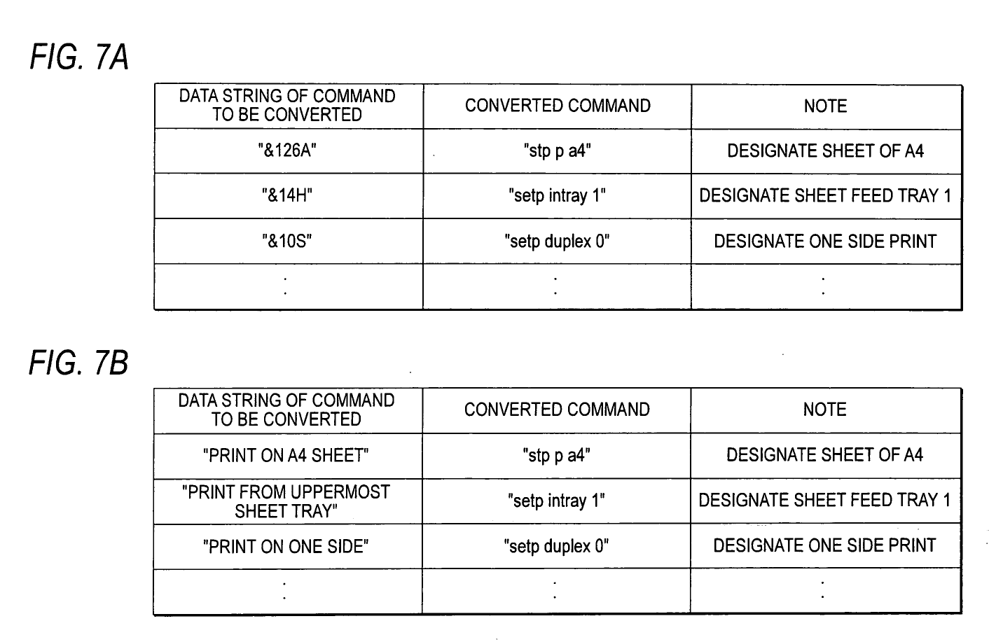

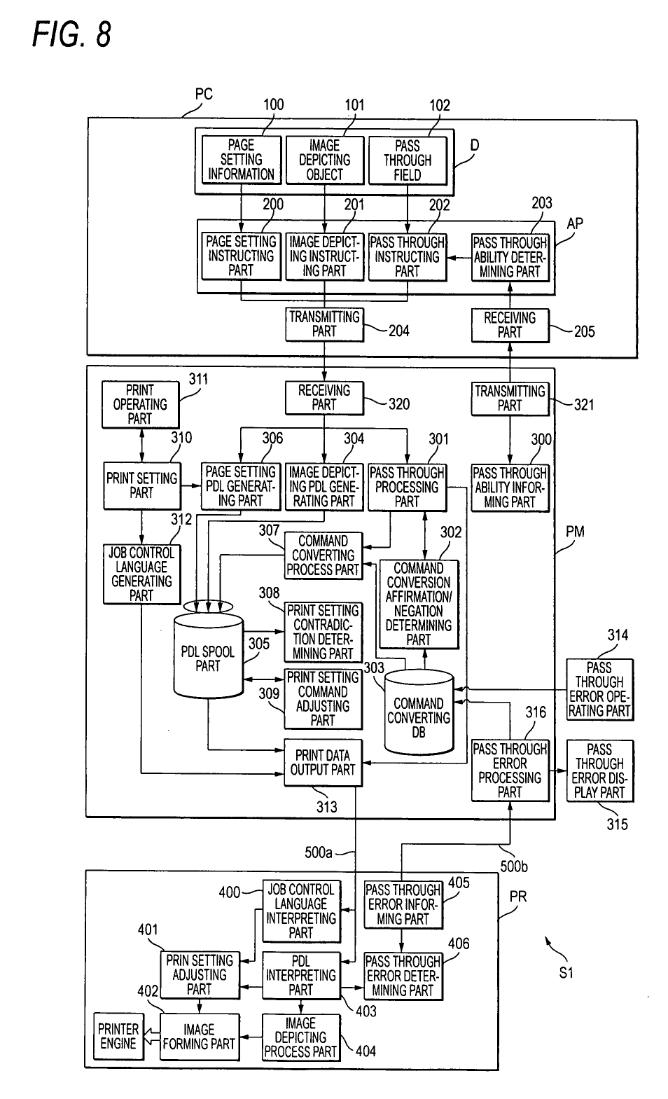

FIG. 1 is a block diagram showing a structure of a printing process system according to a first embodiment of the present invention. FIGS. 2A and 2B are explanatory views showing a structural example of a command in a formed document and a structural example of a print file formed by a print setting instructing device such as a printer driver, respectively. FIG. 5 is a flowchart showing a procedure of a printing process carried out by a printer driver of the printing process system according to the embodiment of the present invention. FIG. 6 is a flowchart showing a procedure of a printing process mainly carried out by a printer of the printing process system according to the embodiment of the present invention. FIG. 7 is a table showing that a printer can interpret pass through commands and examples converted into convert commands having the same contents of control as those of the pass through commands. FIG. 8 is a block diagram showing the structure of a printing process system according to a second embodiment of the present invention.

Before a printing process system as an embodiment is described, a pass through function will be initially described.

For instance, a pass through function (a direct output function) as one of a printer control functions of Windows (a trademark of the Microsoft Corporation) that is an operating system (OS) of the Microsoft Corporation is a function by which a creator of a document can directly control a printer by embedding an arbitrary command delivered from application software (refer it simply to as an application, hereinafter) during printing the document in print data (print information).

More specifically, for instance, one of application functions of the Word (the trademark of the Microsoft Corporation) as a word processor functioning on the Windows includes the pass through function.

When an API Escape( ) function as a pass through command is used, the application can directly deliver data to the printer as a printing device. Further, when the printer driver (a control program) supports the pass through function, if the Escape( ) function and the pass through function are employed, a native printer language code (for instance, native PCL code) can be transmitted to the printer driver.

In the above-described Windows, to support a function peculiar to the printer that is hardly supported by an image depicting function of a GDI (Graphic Device Interface: one of programs installed in the Windows to control a printer or a display, the Escape( ) function is prepared. The pass through function as a function that allows the printer to directly output the printer code is included therein.

The pass through function has a function that permits data to be directly transmitted to the printer when the application does not use a standard printer driver. That is, the data of a spool file image (a printer control code image) can be formed in the application by using the pass through function and directly outputted to the printer.

Specifically, for instance, a print field is inserted into the text of the document created by the Word so that a prescribed command can be transmitted to the printer. The command is transmitted to the printer as the native printer language code.

For instance, when data is embedded in a specific field of the document, the image of the filed is not depicted and is embedded in a print file (print information) transmitted to the printer as pass through data.

When a graph or an equation embedded in the document or data formed in other application is inserted into other application (namely, an object is embedded), the inserted data is adapted to form a part of the document. When a change is added to the object, the change is adapted to be reflected on the document.

The native printer language codes are executed in accordance with a sequence that they are inserted into the document.

Further, a page describing language (PDL) includes PCL (PCL-XL, PCL5, PCL6: trademarks of Hewlett-Packard Development Company), PostScript (a trademark of Advi. Systems Co., Ltd.), LIPS (a trademark of Canon Inc.), ESC/Page (a trademark of Epson Corporation), PRESCRIBE (a trademark of Kyocera Corporation), ARTIV, ARTEX (trademarks of Fuji Xerox Co., Ltd. or the like. In this embodiment, a case using PCL-XL will be described.

Here, to assist a user to understand the printing process system according to this embodiment, by referring to FIGS. 2A and 2B, a structural example of a command (a control instruction) in a document D formed by the application such as the Word and a structural example of a print file formed by the printer driver will be described, respectively.

As shown in FIG. 2A, a setting of “one side print” during a printing operation is outputted to “printer job control language” (job control language: PJL)”. A setting of “automatic sheet feed” during a printing operation is outputted to “page describing language (PDL) of each page”. Further, a setting of “size of a sheet of each page (designated by the application)” during a printing operation is outputted to “page describing language (PDL) of each page”. The pass through command described in the filed of each page is embedded in “page describing language (PDL) of each page”.

The printer driver for supporting the pass through function on the basis of the document D on which the control instruction is described as shown in FIG. 2A forms, for instance, a print file F as shown in FIG. 2B.

In this embodiment, the document D is composed of 4 pages and the print file F includes, for instance, five areas A1 to A5.

In the first area A1, a command for instructing the “one side print” is described by the job control language.

In the area A2, as the PDL of a first page, the “automatic sheet feed”, a “designation of A4”, an “image depicting instruction” or the like are described. In a pass through block B1 formed in an intermediate part, the pass through command for instructing a “manual sheet feed” is embedded.

In the area A3, as the PDL of a second page, the “automatic sheet feed”, the “designation of A4”, the “image depicting instruction” or the like are described.

In the area A4, as the PDL of a third page, the “automatic sheet feed”, the “designation of A4”, the “image depicting instruction” or the like are described. In a pass through block B2 formed in an intermediate part, the pass through command for instructing a “both side print” is embedded.

In the area A5, as the PDL of a fourth page, the “automatic sheet feed”, the “designation of A4”, the “image depicting instruction” or the like are described. In a pass through block B3 formed in an intermediate part, the pass through command for instructing the “both side print” is embedded.

Then, when the print file having the above-described structure is delivered to a printing process unit of the printer to be used, processes are respectively carried out in accordance with the commands of the areas A 1 to A5. In the area A3, since there is no pass through block, the printer perfectly carries out a printing process in accordance with the setting of the printer driver.

The printing process system as the embodiment can be applied to various systems including various kinds of printing processors such as a laser printer, a full color printer, an ink jet printer, a facsimile device, etc.

Now, referring to FIG. 1, the structure of the printing process system S according to this embodiment including a program will be described.

The printing process system S includes an information processor PC composed of a host computer or a personal computer having a processing unit, a program storage device, a memory, an input and output device and a display device, a printer PR as a printing processor and connecting lines (communication line) 500a and 500b for connecting the information processor PC to the printer PR.

In the information processor PC, programs such as the application (a print information generating program) AP such as the Word for creating a document, document data (print information) D formed by the application AP and the printer driver (a control program) PD for controlling a printing process as well as the OS (not shown in the drawing) of the Windows are stored in a hard disk (an illustration is omitted) as the storage device.

The printer driver (the control program) PD may be formed with hardware such as a print setting instructing device (a structural example will be described below).

The document data D includes setting information 100 of each page of the document, an image depicting object 101 as an object whose image is depicted and a pass through field 102 in which a pass through command (a first control instruction) is described.

The application AP includes a page setting instructing part 200 for instructing to set a page in accordance with the setting information 100 of the document data D, an image depicting instructing part 201 for instructing to depict an image in accordance with the image depicting object 101, a pass through instructing part 202 for instructing a pass through process in accordance with the pass through command (the first control instruction) of the pass through field 102 and a pass throughability determining part 203 for determining whether or not there is a pass through processing ability.

The printer driver PD includes a pass through ability informing unit 300 (an informing unit meeting a direct output function) for constantly informing the pass through ability determining part 203 that “there is a pass through processing ability”. Thus, even when the printer PR does not originally have the pass through processing ability, the application AP interprets that the printer supports the pass through function and delivers the pass through command to the printer driver PD. Further, a pass through processing part 301 is provided for receiving the pass through command (the first control instruction) from the pass through instructing part 202 of the application AP.

A command converting data base (DB) 303 is a data base in which data (table information) of a command converting table is stored for converting the pass through command (the first control instruction) into a converted command (a second control instruction) that can be interpreted by the printer PE and has the same contents of control as those of the pass through command (the first control instruction. To the command converting data base (DB) 303, are connected a command conversion affirmation/negation determining part 302 for determining whether or not the pass through command (the first control instruction) needs to be converted into the converted command (the second control instruction) and a command converting process part 307 as a control instruction converting unit for carrying out a converting process for converting the pass through command (the first control instruction) to the converted command (the second control instruction) that can be interpreted by the printer PR and has the same contents of control as those of the pass through command (the first control instruction) when a conversion is necessary.

A determined instruction from the command conversion affirmation/negation determining part 302 is sent to the pass through processing part 301 and a converting instruction is sent to the command converting process part 307 from the pass through processing part 301. Further, the pass through processing part 301 is connected to a print data output part 313 that outputs formed print data to the printer PR.

Thus, processes are carried out in such a way that after the command from the application AP undergoes the pass through process, the command conversion affirmation/negation determining part 302 determines whether or not the command is an object to be converted, and when the command is a command as an object to be converted (the first control instruction), the command converting process part 307 converts the command to a command (the second control instruction) coordinated therewith, and when the command is not an object to be converted, the pass through processing part 301 directly applies the pass through process to the command to output the command from the print data output part 313.

Further, to the command converting data base (DB) 303, a pass through error operating part 314 is connected. The pass through error operating part 314 is an operating part for updating the command converting table by additionally registering a command by a user when a below-described error is generated. The pass through error operating part 314 may be formed with a pointing device such a keyboard or a mouse connected to the information processor PC.

Further, to the command converting data base (DB) 303, are connected a pass through error processing part 316 for adding data string of a prescribed converting command (the second control instruction) as a converted side to the command converting table and a pass through error display part 315 for informing, during the generation of the error, a user that the command (the second control instruction) of the converted side corresponding to the pass through command (the first control instruction) is to be registered. The pass through error display part 315 may be formed with a display monitor connected to the information processor PC.

The command converting process part 307 is connected to a PDL spool part (a holding unit) 305 for spooling the converted command for one page.

Further, to the PDL spool part 305, are connected an image depicting PDL generating part 304 for generating a PDL command (a third control instruction) for depicting an image in accordance with an instruction of the image depicting instructing part 201 of the application AP and a page setting PDL generating part (serves also as a syntax analyzing unit) 306 for generating a PDL command (a third control instruction) for setting a page in accordance with an instruction of the page setting instructing part 200.

Further, to the PDL spool part 305, is connected a print setting contradiction determining part (a contradiction determining unit) 308 for determining whether or not a contradiction exists between printing settings by a PDL command (the third control instruction) for setting a page formed by the printer driver PD itself on the basis of document data D in accordance with a determined instruction from the PDL spool part 305 and the pass through command (the first control instruction) or the converted command (the second control instruction) when the pass through command is converted by the command converting process part 307.

Further, the print setting contradiction determining part 308 is connected to a print setting command adjusting part (a print adjusting unit, a moving unit and a setting content replacing unit) 309 for carrying out adjusting processes that any of the printing settings is neglected in accordance with a preset priority; the pass through command (the first control instruction) or the converted command (the second control instruction) when the conversion is carried out is moved to a position where the setting is valid; and a print setting by the page setting PDL command (the third control instruction) formed by the printer driver PD is replaced by the print setting by the pass through command (the first control instruction) or the converted command (the second control instruction) when the conversion is carried out. Thus, the data is transmitted and received between the PD spool part 305 and the print setting command adjusting part 309.

Further, a print setting part 310 of the printer driver PD is connected to a print operating part 311 for carrying out a print setting. The print operating part 311 may be formed with a pointing device such as a keyboard or a mouse connected to the information processor PC.

Further, the print setting part 310 is connected to the print data output part 313 through a job control language generating part 312.

Now, for the printer PR, only a control system (for instance, composed of a microcomputer) will be described and a detailed explanation of the structure of a printer engine E for carrying out a printing operation will be omitted. The printer engine E may be applied suitably to meet the kinds of the printers (for instance, a laser printer, a full color printer, an ink jet printer, etc.).

A job control language interpreting part 400 of the printer PR is connected to the print data output part 313 of the information processor PC through the connecting line 500a to receive print data formed in the information processor PC and interpret the contents set by a job control language.

Further, a PDL interpreting part 403 is also connected to the print data output part 313 of the information processor PC to receive the print data formed in the information processor PC and interpret the contents set by a PDL (a page describing language). Then, the interpreted results of the job control language interpreting part 400 and the PDL interpreting part 403 are delivered to a print setting adjusting part 401 to match (adjust) the setting contents and output an instruction to an image forming part 402 to form an image. Further, the interpreted result of the PDL interpreting part 403 is also delivered to an image depicting process part 404 and the image depicting process part 404 also outputs an instruction to the image forming part 402 to form an image.

Then, image information formed in the image forming part 402 is supplied to the printer engine E to carry out a printing process.

Further, to the PDL interpreting part 403, is connected a pass through error determining part 406 for detecting the pass through command (the first control instruction) (not converted) that cannot be interpreted and a determined result is sent to a pass through error informing part 405.

The pass through error informing part 405 is connected to the pass through error processing part 316 of the information processor PC through the connecting line 500b and the information of the pass through command (the first control instruction) (not converted)) that cannot be interpreted is transmitted to the printer driver PD.

The pass through error processing part 316 adds the data string of the pass through command (the first control instruction (not converted)) that cannot be interpreted to the command converting table of the command converting data base 303 of the printer driver PD in accordance with the information of the pass through command (the first control instruction (not converted)) tat cannot be interpreted and informs a user through the pass through error display part 315 that the command of the converted side (the second control instruction (the converted side)) corresponding to the pass through command (the first control instruction (not converted)) which cannot be interpreted is to be registered (for instance, display a message such as “register . . . command in a data base.”).

Then, the user operates the pass through error operating part 314 in accordance with the above-described information to additionally register the command, so that the command converting table is updated.

In the structure shown in FIG. 1, a case is shown that the command is converted and the converted command is spooled in the information processor PC side, however, the present invention is not limited thereto and a command converting process and a spool process of the converted command may be carried out in the printer PR side. In this case, the printer driver PD directly transmits the command formed by itself and the pass through processed command from the application AP to the printer PR through the connecting lines 500a and 500b. Thus, the PR side carries out the above-described processes for each page unit or each job unit and then interprets each command.

Still further, a printing process system may be provided that the plurality of information processors PC, the printers PR and printer server devices are connected together through a network such as a LAN in place of the connecting lines 500a and 500b.

In such a printing process system, the command converting process and the spool process may be carried out in the print server device. In this case, the printer driver PD directly transmits the command formed by itself and the pass through processed command from the application AP to the print server device. Thus, the print server device carries out the command converting process and the spool process for each page unit or each job unit and then transmits data to the printer PR through the network.

As a method for converting the command in the command converting process part, a system that the printer driver PD is provided with a simple parser (a syntax analyzing unit) that can interpret only a command related to a print control to interpret the pass through processed command and replace the command by the command that can be interpreted by the printer PR and has the same meaning as that of the pass through processed command may be used as well as the system that the printer driver PD is provided with the command converting table to register the data string of the command desired to pass through processed and the command that can be interpreted by the printer PR and has the same meaning as that of the data string of the command desired to be pass through processed so as to coordinate them (the command converting data base 303) as described by referring to FIG. 1.

Now, a procedure of the printing process carried out by the printer driver PD of the printing process system S having the above-described structure will be described by referring to a flowchart shown in FIG. 5.

When the printing process is started, firstly, in step S1, “there is a pass through processing ability” is reported from the pass through ability informing part 300 of the printer driver PD to the pass through ability determining part 203 of the application AP to shift to step S2. In the step S2, the image depicting PDL generating part 304 of the printer driver PD receives an image depicting instruction from the image depicting instructing part 201 of the application AP to advance to step S3.

In the step S3, whether or not a pass through block is started is determined in the pass through processing part 301. When a determined result is “Yes”, the procedure shifts to step S11. When the determined result is “No”, procedure shifts to step S4.

In the step S4, a generating process of an ordinary PDL command (the third control instruction) is carried out in the image depicting PDL generating part 304 and the page setting PDL generating part 306. Then, in step S5, a process is carried out for spooling the generated PDL command (the third control instruction) in the PDL spool part 305.

Then, the procedure shifts to step S6 to determine whether or not a page is completed. When a determined result is “No”, the procedure returns to the step S2. When the determined result is “Yes”, the procedure shifts to step S7 to determine whether or not a contradiction exists between the print setting of the page setting PDL command (the third control instruction) formed by the printer driver PD and the print setting of the pass through command (the first control instruction) in the print setting contradiction determining part 308.

Then, when it is determined that the contradiction exists, the procedure shifts to step S8 to carry out a process for avoiding the contradiction of the print setting in the print setting command adjusting part 309. Specifically, the adjusting processes are carried out that any of the printing settings is neglected in accordance with a preset priority; the pass through command (the first control instruction) or the converted command (the second control instruction (the converted side)) when the conversion is carried out is moved to a position where the setting is valid; and a print setting by the page setting PDL command (the third control instruction) formed by the printer driver PD is replaced by the print setting by the pass through command (the first control instruction) or the converted command (the second control instruction) when the conversion is carried out. That is, for instance, when the size of a sheet is set by the page setting PDL command formed by the printer driver PD, a certain image is depicted, and subsequently, the size of the sheet is set again by the pass through function, the above-described adjusting process is carried out. Further, when it is determined that the contradiction does not exist, the procedure shifts to step S9 to discard the command spooled in the PDL spool part 305 and shift to step S10.

In the step S10, it is determined whether or not a job is completed. When a determined result is “No”, the procedure returns to the step S2 to continuously carry out the processes. When the determined result is “Yes”, the process is finished.

On the other hand, in step S11, it is determined whether or not there is a command as an object to be converted in the pass through block in the command conversion affirmation/negation determining part 302. When a determined result is “No”, the procedure shifts to step S12 to carry out a process for embedding the command (the first control instruction) as shown in FIG. 2B and then shifts to step S13.

In the step S13, the command (the first control instruction) is spooled, and then, the procedure returns to the step S2 to continuously carry out the processes.

Further, when the determined result is “Yes”, the procedure shifts to step S14 to carry out a converting process of the pass through command (the first control instruction) in the command converting process part 307, then shifts to step S15 to carry out a process for embedding the converted command as shown in FIG. 2B and then shifts to step S16.

In the step S16, the converted PDL command is spooled in the PDL spool part 305, and then, the procedure returns to the step S2 to continuously carry out the processes.

Now, a procedure of the printing process mainly carried out by the printer PR of the printing process system S having the above-described structure will be described by referring to a flowchart shown in FIG. 6.

When the printing process is started in the printer PR, in step S20, “a pass through processing ability exists” is initially reported from the pass through ability informing part 300 of the printer driver PD side to the pass through ability determining part 203 of the application AP to shift to step S21. In the step S21, the pass through processing part 301 of the printer driver PD side carries out the pass through process to shift to step S22. Then, the pass through error determining part 406 of the printer PR side determines whether or not there is a command that cannot be interpreted in the pass through block.

Then, when a determined result is “No”, the procedure shifts to step S23 to carry out an ordinary printing process by the image depicting process part 404 and finish the process.

On the other hand, when the determined result is “Yes”, the procedure shifts to step S24 to report the data string of the command that cannot be interpreted to the pass through error processing part 316 of the printer driver PD from the pass through error informing part 405 and advances to step S25.

In the step S25, the pass through error processing part 316 adds the data string of the command that cannot be interpreted to the command converting data base 303 and then, the procedure shifts to step S26.

In the step S26, a user is informed of the registration of the converted command of the data string by the display of a message in the pass through error display part 315. In step S27, it is determined whether or not the pass through error operating part 314 is operated by the user. When a determined result is “No”, the procedure is stood by as it is. When the determined result is “Yes”, the procedure shifts to step S28 to add the registered command of the converted side to the command converting data base 303 and shifts to step S29.

In the step S29, it is determined whether or not the printing process can be continuously carried out. When a determined result is “Yes”, the procedure shifts to the step S23 to carry out the ordinary printing process by the image depicting process part 404 and then finish the process. When the determined result is “No”, the process is directly finished.

Here, by referring to FIG. 7, an example will be described that the pass through command (the first control instruction) is converted into the converted command (the second control instruction) that can be interpreted by the printer PR and has the same contents of control as those of the pass through command (the first control instruction) by the above-described printing process system S and the printing process.

In this example, as the pass through command (the first control instruction) that can not be interpreted by the printer PR, PDL5 (a trademark of Hewlett-Packard Development Company) is supposed, and as the converted command that can be interpreted by the printer PR, ARTIV (a trademark of Fuji Xerox Co., Ltd.) is supposed.

In FIG. 7A, for instance, as for the contents of setting of “a designation of a sheet of A4”, when the data string of the command as an object to be converted that cannot be interpreted by the printer PR is “&126A”, the command is converted into a command of “stp p a4” that can be interpreted by the printer PR and has the same contents of control as those of the pass through command (the first control instruction). Similarly, as for the contents of setting of “a designation of a sheet feed tray 1”, “&14H” is converted into “setp intray 1”. As for the contents of setting of “a designation of one side print”, “&I0S” is converted to “setup duplex 0”.

Further, in a converting table registered in the command converting data base 303, a command composed of “an arbitrary character string” may be coordinated with the command of the converted side so that the command is converted as shown in FIG. 7B.

Specifically, for instance, the command of the character string of “print on a sheet of A4” is converted to “stp p a4”, the command of the character string of “print from an uppermost sheet tray” is converted to “setp intray 1” and the command of the character string of “print on one side” is converted to “setp duplex 0”.

Now, referring to a block diagram shown in FIG. 8, a printing process system S1 according to a second embodiment of the present invention will be described.

A difference of the printing process system S1 of the second embodiment from the printing process system S according to the first embodiment resides in that a print setting instructing device PM composed of hardware is provided in place of the printer driver PD.

The same structures as those of the printing process system S according to the first embodiment are designated by the same reference numerals.

The printing process system S1 includes an information processor PC composed of a host computer or a personal computer, a print setting instructing device PM, a printer PR as a printing processor and connecting lines (communication line) 500a and 500b for connecting the information processor PC to the printer PR.

In the information processor PC, programs such as an application (a print information generating program) AP and document data (print information) D formed by the application AP are stored in a hard disk (an illustration is omitted) as a storage device.

Further, information is transmitted to and received from the print setting instructing device PM through a transmitting part 204 and a receiving part 205 formed with a modem.

The document data D includes setting information 100 of each page of a document, an image depicting object 101 as an object whose image is depicted and a pass through field 102 in which a pass through command (a first control instruction) is described.

The application AP includes a page setting instructing part 200 for instructing to set a page in accordance with the setting information 100 of the document data D, an image depicting instructing part 201 for instructing to depict an image in accordance with the image depicting object 101, a pass through instructing part 202 for instructing a pass through process in accordance with the pass through command (the first control instruction) of the pass through field 102 and a pass through ability determining part 203 for determining whether or not there is a pass through processing ability.

The print setting instructing device PM includes a pass through ability informing unit 300 (an informing unit meeting a direct output function) for constantly informing the pass through ability determining part 203 that “there is a pass through processing ability” through a transmitting part 321 formed with the modem. Thus, even when the printer PR does not originally have the pass through processing ability, the application AP interprets that the printer supports the pass through function and delivers the pass through command to the print setting instructing device PM. Further, a pass through processing part 301 is provided for receiving the pass through command (the first control instruction) from the pass through instructing part 202 of the application AP.

Data or instructing information outputted from the transmitting part 204 of the information processor PC is received through a receiving part 320 (a receiving unit) provided in the print setting instructing device PM.

A command converting data base (DB) 303 is a data base in which data (table information) of a command converting table is stored for converting the pass through command (the first control instruction) into a converted command (a second control instruction) that can be interpreted by the printer PE and has the same contents of control as those of the pass through command (the first control instruction. To the command converting data base (DB) 303, are connected a command conversion affirmation/negation determining part 302 for deciding whether or not the pass through command (the first control instruction) needs to be converted into the converted command (the second control instruction) and a command converting process part 307 as a control instruction converting unit for carrying out a converting process for converting the pass through command (the first control instruction) to the converted command (the second control instruction) that can be interpreted by the printer PR and has the same contents of control as those of the pass through command (the first control instruction) when a conversion is necessary.

A determined instruction from the command conversion affirmation/negation determining part 302 is sent to the pass through processing part 301 and a converting instruction is sent to the command converting process part 307 from the pass through processing part 301. Further, the pass through processing part 301 is connected to a print data output part 313 that outputs formed print data to the printer PR.

Thus, processes are carried out in such a way that after the command from the application AP undergoes the pass through process, the command conversion affirmation/negation determining part 302 determines whether or not the command is an object to be converted, and when the command is a command as an object to be converted (the first control instruction), the command converting process part 307 converts the command to a command (the second control instruction) coordinated therewith, and when the command is not an object to be converted, the pass through processing part 301 directly applies the pass through process to the command to output the command from the print data output part 313.

Further, to the command converting data base (DB) 303, a pass through error operating part 314 is connected. The pass through error operating part 314 is an operating part for updating the command converting table by additionally registering a command by a user when a below-described error is generated. The pass through error operating part 314 may be formed with a pointing device such a keyboard or a mouse connected to the information processor PC.

Further, to the command converting data base (DB) 303, are connected a pass through error processing part 316 for adding the data string of a prescribed command (the second control instruction) as a converted side to the command converting table and a pass through error display part 315 for informing, during the generation of the error, a user that the command (the second control instruction) of the converted side corresponding to the pass through command (the first control instruction) is to be registered.

The command converting process part 307 is connected to a PDL spool part (a holding unit) 305 for spooling the converted command for one page.

Further, to the PDL spool part 305, are connected an image depicting PDL generating part 304 for generating a PDL command (a third control instruction) for depicting an image in accordance with an instruction of the image depicting instructing part 201 of the application AP and a page setting PDL generating part (serves also as a syntax analyzing unit) 306 for generating a PDL command (a third control instruction) for setting a page in accordance with an instruction of the page setting instructing part 200.

Further, to the PDL spool part 305, is connected a print setting contradiction determining part (a contradiction deciding unit) 308 for deciding whether or not a contradiction exists between printing settings by a PDL command (the third control instruction) for setting a page formed by the print setting instructing device PM itself on the basis of document data D in accordance with a determined instruction from the PDL spool part 305 and the first control instruction or the second control instruction converted by the command converting process part 307.

Further, the print setting contradiction determining part 308 is connected to a print setting command adjusting part (a print adjusting unit, a moving unit and a setting content replacing unit) 309 for carrying out adjusting processes that any of the printing settings is neglected in accordance with a preset priority; the converted PDL command (the second control instruction) or the first control instruction when a conversion is not carried out is moved to a position where the setting is valid; and a print setting by the page setting PDL command (the third control instruction) formed by the print setting instructing device PM is replaced by the print setting by the converted PDL command (the second control instruction) or the first control instruction when the command is not converted intro the second control instruction. Thus, the data is transmitted and received between the PD spool part 305 and the print setting command adjusting part 309.

Further, a print setting part 310 of the print setting instructing device PM is connected to a print operating part 311 for carrying out a print setting.

Further, the print setting part 310 is connected to the print data output part 313 through a job control language generating part 312.

Now, for the printer PR, a job control language interpreting part 400 of the printer PR is connected to the print data output part 313 of the print setting instructing device PM through the connecting line 500a to receive print data formed in the print setting instructing device PM and interpret the contents set by a job control language.

Further, a PDL interpreting part 403 is also connected to the print data output part 313 of the print setting instructing device PM to receive the print data formed in the print setting instructing device PM and interpret the contents set by a PDL (a page describing language). Then, the interpreted results of the job control language interpreting part 400 and the PDL interpreting part 403 are delivered to a print setting adjusting part 401 to match (adjust) the setting contents and output an instruction to an image forming part 402 to form an image. Further, the interpreted result of the PDL interpreting part 403 is also delivered to an image depicting process part 404 and the image depicting process part 404 also outputs an instruction to the image forming part 402 to form an image.

Then, image information formed in the image forming part 402 is supplied to a printer engine E to carry out a printing process.

Further, to the PDL interpreting part 403, is connected a pass through error determining part 406 for detecting the pass through command (the first control instruction) (not converted) that cannot be interpreted and a determined result is sent to a pass through error informing part 405.

The pass through error informing part 405 is connected to the pass through error processing part 316 of the print setting instructing part PM through the connecting line 500b and the information of the pass through command (the first control instruction)(not converted)) that cannot be interpreted is transmitted to the print setting instructing device PM.

The pass through error processing part 316 adds the data string of the pass through command (the first control instruction (not converted)) that cannot be interpreted to the command converting table of the command converting data base 303 of the print setting instructing device PM in accordance with the information of the pass through command (the first control instruction) (not converted)) that cannot be interpreted and informs a user through the pass through error display part 315 that the command of the converted side (the second control instruction (the converted side)) corresponding to the pass through command (the first control instruction (not converted)) which cannot be interpreted is to be registered (for instance, display a message such as “register . . . command in a data base.”).

Then, the user operates the pass through error operating part 314 in accordance with the above-described information to additionally register the command, so that the command converting table is updated.

The present invention devised by the inventor is specifically described in accordance with the embodiments, however, it is to be understood that the embodiments disclosed in this specification are exemplified in view of all points and are not limited to the disclosed technique. That is, a technical scope of the present invention is not restrictively interpreted in accordance with the description of the embodiments and shall be interpreted in accordance with the description in claims, and a technique equivalent to the technique described in claims and all changes within claims are included.

When the program is used in the print processing systems S and S1, the program can be provided through a network or by storing the program in a recording medium such as a CD-ROM.

What is claimed is:

1. A print setting instructing device comprising:
a receiving unit that receives a first control instruction, which shows a print condition, embedded in a printed;
a determining unit that determines whether or not the first control instruction received by the receiving unit needs to be converted into a second control instruction; and
a converting unit that converts the first control instruction into the second control instruction in a case where the determining unit determines that the converting the first control instruction into the second control instruction is necessary.

2. The print setting instructing device as claimed in claim 1, further comprising:
a storage that coordinates and stores the first control instruction with the second control instruction,
wherein
the converting unit converts the first control instruction into the second control instruction on the basis of a coordination between the first control instruction and the second control instruction stored by the storage.

3. The print setting instructing device as claimed in claim 1, further comprising:
a syntax analyzing unit that analyzes a syntax of the first control instruction,
wherein
the determining unit determines whether or not the first control instruction is converted into the second control instruction in accordance with a result analyzed by the syntax analyzing unit.

4. The print setting instructing device as claimed in claim 1, further comprising:
a generating unit that generates a third control instruction showing the print condition to the printed document;
a suspending unit that sequentially suspends the third control instruction generated by the generating unit and one of the first control instruction and the second control instruction; and
a determining unit that determines whether or not there is a contradiction in the contents of the print condition between the third control instruction and one of the first control instruction and the second control instruction suspended by the suspending unit.

5. The print setting instructing device as claimed in claim 4, further comprising:
an executing unit that executes a printing process by neglecting any of the print condition in accordance with a preset priority in a case where the determining unit determines that there is a contradiction in the contents of the print condition between one of the first control instruction and the second control instruction and the third control instruction.

6. The print setting instructing device as claimed in claim 4, further comprising:
a moving unit that, in a case where the determining unit determines that there is the contradiction in the contents of the print condition between one of the first control instruction and the second control instruction and the third control instruction, moves a describing position of one of the first control instruction and the second control instruction in the print information to a position where the contradiction in the contents of the setting condition of the print does not arise.

7. The print setting instructing device as claimed in claim 4, further comprising:
a replacing unit that, in a case where the determining unit determines that there is a contradiction in the contents of the print condition between one of the first control instruction and the second control instruction and the third control instruction, replaces the print setting of the third control instruction by the contents of the setting condition of the print of one of the first control instruction and the second control instruction.

8. The print setting instructing device as claimed in claim 1, further comprising:
an information receiving unit that receives the information of the first control instruction which can not be interpreted by a printing device;
an adding unit that adds the first control instruction reported by the information receiving unit to the information; and
a registering unit that registers the second control instruction which corresponds to the first control instruction added by the adding unit and can be interpreted by the printing device.

9. An information processor comprising:
an extracting unit that extracts a first control instruction, which shows the setting condition of a print, embedded in a printed document and;
a determining unit that determines whether or not the first control instruction extracted by the extracting unit needs to be converted into a second control instruction; and
a converting unit that converts the first control instruction into the second control instruction in a case where the determining unit determines that the converting the first control instruction into the second control instruction is necessary.

10. A printing process system comprising:
the information processor according to claim 9 that at least executes a print information generating program which generates the print information including the control instruction; and
a printing device that executes a printing process on the basis of the print information supplied from the information processor.

11. A print setting instructing method comprising:
receiving a first control instruction embedded in a printed document and showing a print condition;
determining whether or not the received first control instruction needs to be converted into a second control instruction; and
converting the first control instruction into the second control instruction in a case where the converting the first control instruction into the second control instruction is necessary in the determining of necessity of a conversion.

12. A computer readable medium storing a program causing a computer to execute a process for controlling a printing process, the process comprising:
a receiving a first control instruction embedded in a printed document, the first control instruction showing a print condition;
a determining whether or not the first control instruction received in the receiving of the first control instruction needs to be converted into a second control instruction; and
a converting the first control instruction into the second control instruction in a case where the converting the first control instruction into the second control instruction is necessary in the determining of necessity of a conversion.

13. A computer readable medium storing a program causing a computer to execute a process for controlling a printing process, the process comprising:
an extracting a first control instruction embedded in a printed document, the first control instruction showing a print condition;
a determining whether or not the first control instruction extracted in the extracting of the first control instruction needs to be converted into a second control instruction; and
a converting the first control instruction into the second control instruction in a case where the converting the first control instruction into the second control instruction is necessary in the determining of necessity of a conversion.
